(19) United States
(12) Patent Application Publication
(10) Pub. No.: US 2023/0184087 A1
(43) Pub. Date: Jun. 15, 2023

(54) Multi-modal and Multi-dimensional Geological Core Property Prediction using Unified Machine Learning Modeling

(71) Applicant: Saudi Arabian Oil Company, Dhahran (SA)

(72) Inventors: Tao Lin, Katy, TX (US); Mokhles Mustapha Mezghani, Dhahran (SA); Chicheng Xu, Houston, TX (US); Weichang Li, Katy, TX (US)

(21) Appl. No.: 17/549,743

(22) Filed: Dec. 13, 2021

(51) Int. Cl. E21B 47/002; E21B 47/04; E21B 47/12

(52) U.S. Cl. CPC E21B 47/0025; E21B 47/04; E21B 47/138; E21B 2200/22

(57) ABSTRACT

A computer-implemented method, medium, and system for geological core property prediction using machine learning modeling are disclosed. In one computer-implemented method, multiple imagery data of a core sample of a wellbore are received. The multiple imagery data are partitioned into multiple image patches. Multiple first vectors of encoded features in a latent space are generated based on the multiple image patches. Multiple image features of the core sample of the wellbore are generated based on the multiple imagery data. Multiple second vectors of encoded features in the latent space are generated based on the multiple image features. Multiple rock properties associated with the core sample of the wellbore are predicted by running a regressor in the DFCN based on the multiple first vectors and the multiple second vectors. The multiple rock properties are provided for determining multiple properties of a subsurface reservoir that includes the wellbore.

### TECHNICAL FIELD

The present disclosure relates to computer-implemented methods, medium, and systems for multi-modal and multi-dimensional geological core property prediction using unified machine learning modeling.

### BACKGROUND

Rock properties including petrophysical properties (porosity and permeability), geomechanical properties (Poisson's ratio and Young's modulus), and geochemical properties (Total organic carbon and kerogen volume) are important for subsurface reservoir modeling. Lab measurements of these properties based on core plugs are generally reliable and often considered as the ground truth. However, for time and cost considerations, core plug measurements are selectively conducted and therefore discrete in depth covering limited intervals of the wellbore.

### SUMMARY

The present disclosure involves computer-implemented method, medium, and system for multi-modal and multi-dimensional geological core property prediction using unified machine learning modeling. One example computer-implemented method includes receiving multiple imagery data of a core sample of a wellbore. The multiple imagery data of the core sample of the wellbore are partitioned, as input to a convolutional neural network (CNN), into multiple image patches at multiple locations along vertical direction of the core sample of the wellbore. Multiple first vectors of encoded features in a latent space are generated as output from the CNN and by running the CNN based on the multiple image patches of the core sample of the wellbore. Multiple image features of the core sample of the wellbore are generated as input to a deep fully connected network (DFCN) and based on the multiple imagery data of the core sample of the wellbore, where the multiple image features of the core sample of the wellbore are associated with numerical features of the multiple imagery data of the core sample of the wellbore. Multiple second vectors of encoded features in the latent space are generated as output from the DFCN and by running the DFCN based on the input to the DFCN. Multiple rock properties associated with the core sample of the wellbore are predicted by running a regressor in the DFCN based on the output from the CNN and the output from the DFCN. The multiple rock properties are provided for determination of multiple properties of a subsurface reservoir, where the core sample of the wellbore is from the subsurface reservoir.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts an environment architecture of an example computer-implemented system that can execute implementations of the present disclosure.

FIG. 2 illustrates an example system architecture of unified machine learning modeling, in accordance with example implementations of this disclosure.

FIG. 3A, FIG. 3B, and FIG. 3C are each an example illustration of input data from multiple wellbores, in accordance with example implementations of this disclosure.

FIG. 4 illustrates examples of extracted image patches from several core samples, in accordance with example implementations of this disclosure.

FIG. 5 illustrates examples of image patches extracted near core plugs, in accordance with example implementations of this disclosure.

FIG. 6 illustrates examples of processed image features and image patches, in accordance with example implementations of this disclosure.

FIG. 7A and FIG. 7B illustrate an example of unified machine learning model building workflow, in accordance with example implementations of this disclosure.

FIG. 8 illustrates example results of rock property prediction, in accordance with example implementations of this disclosure.

FIG. 9 is a flowchart illustrating an example of a method for implementing multi-modal and multi-dimensional geological core property prediction using unified machine learning modeling, in accordance with example implementations of this disclosure.

FIG. 10 is a schematic illustration of example computer systems that can be used to execute implementations of the present disclosure.

### DETAILED DESCRIPTION

Common core analysis methods are available at sparsely sampled plug locations within the core, and they may miss important heterogeneity (e.g. near fault) that is important for determining reservoir properties. Therefore, the direct rock properties measurements from plugs are very limited in sampling interval. Meanwhile, other information related to the core, such as core photos, core gamma-ray, and CT measurements are available at high resolution throughout. Additionally, core analysis and other relevant information generate a large number of heterogeneous formats data, and integration of these data into a single modeling framework can be challenging.

It also remains challenging to assimilate these high-resolution data to provide a continuous, high resolution prediction of rock properties across the entire core, with the accuracy of the actual, but sparse plug data. Machine learning can be used to identify facies and bedding structures and upscale plug measurements to the entire core section, which can produce a high-resolution estimate of rock properties in a fraction of the time of conventional methods. However, these technologies only use the core scans data or texture measurements profile from pre-defined features (e.g. Haralick features), or core images alone.

This disclosure describes technologies for multi-modal and multi-dimensional geological core property prediction using unified machine learning modeling. In some implementations, the multi-modal multi-dimensional core sample data include both imagery array data and numeric sequence data. This enables prediction of core properties from core images, core scans and well logs as multi-modal multi-dimensional inputs.

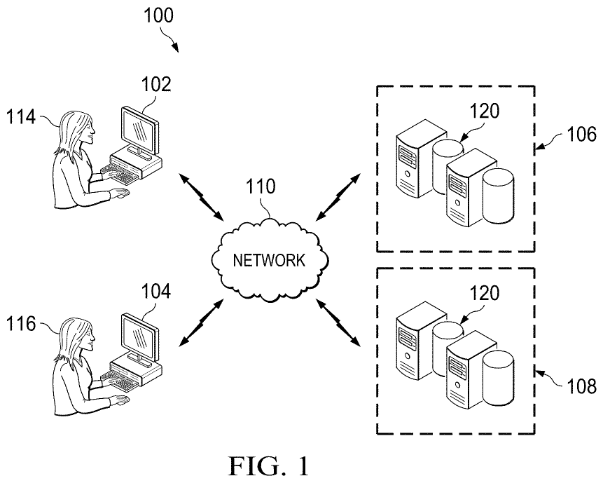

FIG. 1 depicts an environment architecture of an example computer-implemented system 100 that can execute implementations of the present disclosure. In the depicted example, the example system 100 includes a client device 102, a client device 104, a network 110, and a cloud environment 106 and a cloud environment 108. The cloud environment 106 may include one or more server devices and databases (e.g., processors, memory). In the depicted example, a user 114 interacts with the client device 102, and a user 116 interacts with the client device 104.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the cloud environment 106 include at least one server and at least one data store 120. In the example of FIG. 1, the cloud environment 106 is intended to represent various forms of servers including, but not limited to, a web server, an application server, a proxy server, a network server, and/or a server pool. In general, server systems accept requests for application services and provides such services to any number of client devices (e.g., the client device 102 over the network 110).

In accordance with implementations of the present disclosure, and as noted above, the cloud environment 106 can host applications and databases running on host infrastructure. In some instances, the cloud environment 106 can include multiple cluster nodes that can represent physical or virtual machines. A hosted application and/or service can run on VMs hosted on cloud infrastructure. In some instances, one application and/or service can run as multiple application instances on multiple corresponding VMs, where each instance is running on a corresponding VM.

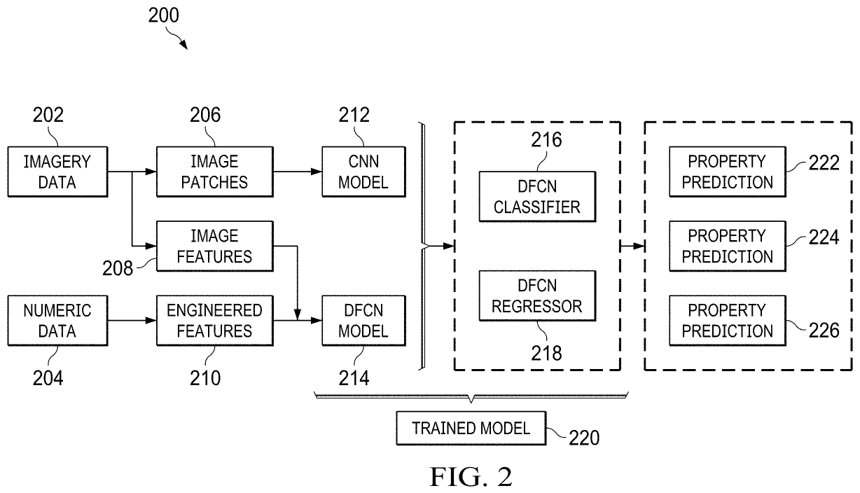

FIG. 2 illustrates an example system architecture 200 of unified machine learning (ML) modeling, in accordance with example implementations of this disclosure. In some implementations, image patches 206 and image features 208 are extracted from imagery data 202, filtered, and pre-processed. Example of imagery data 202 can be photos of core samples of a wellbore. Convolutional Neural Network (CNN) model 212 is used to extract patterns out of image patches 206. Deep Fully Connected Network (DFCN) model 214 is used to process numerical value inputs including image features 208, as well as engineered features 210 extracted from numeric data 204. Examples of numeric data 204 can be various core sample scans and well logs. A hybrid model 220 combines CNN model 212, DFCN model 214, DFCN classifier 216, and DFCN regressor 218, uses image data 202 and numeric data 204 collected at the core-plug depth locations for training, and uses rock property measurements from core plugs of the core samples of the wellbore as labels. The trained hybrid model 220 is then applied to specified depth range/locations of the core sample, as well as new core samples, to predict rock properties of the wellbore, with or without retraining. When additional information for different core depth samples are available, for example, geological formation, diagenetic or litho-facies, carbonate vs clastic or sands, these additional information can be incorporated into the unified machine learning workflow through pre-processing/pre-classification for different use cases. One example use case is to generate additional numerical or categorical input features to be included in the training and testing of the same hybrid training model 220. These input features are used as input to DFCN model 214. Another example use case is to help to partition data samples into subsets which can then be trained and tested separately (with the same or different model structures), to improve accuracy and interpretation ability of the trained model 220. The subsets are used to train the hybrid model 220 and to predict rock properties. The unified machine learning system can be implemented to integrate the aforementioned workflow. Users of the unified machine learning system can customize the workflow with data and model management and model hyperparameters tuning, and visualize the results of rock property prediction.

Example steps of the aforementioned workflow of the unified machine learning system are described next.

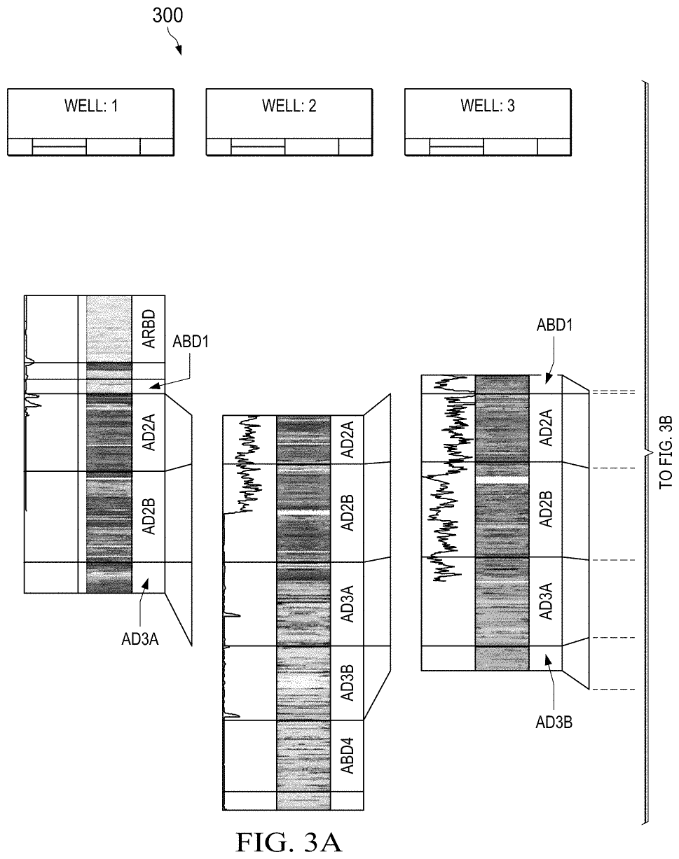

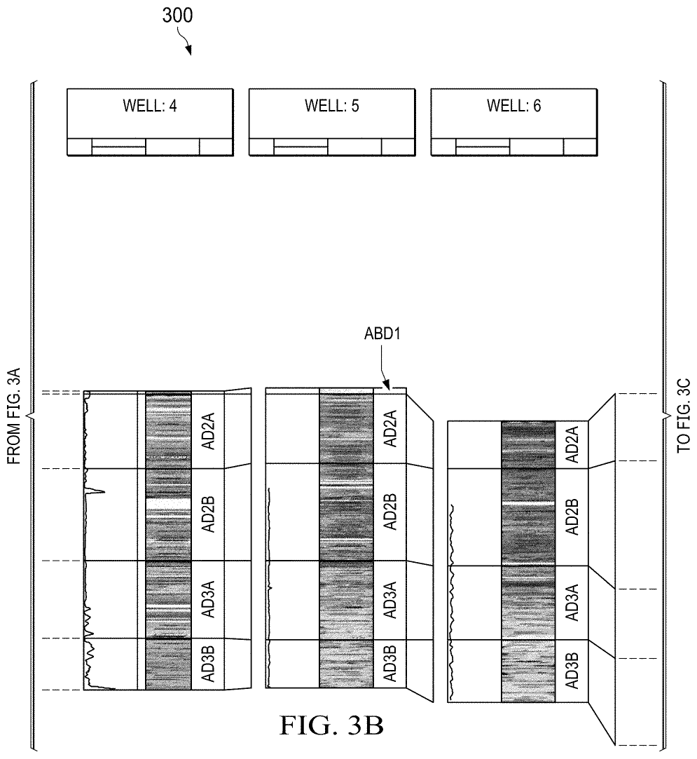

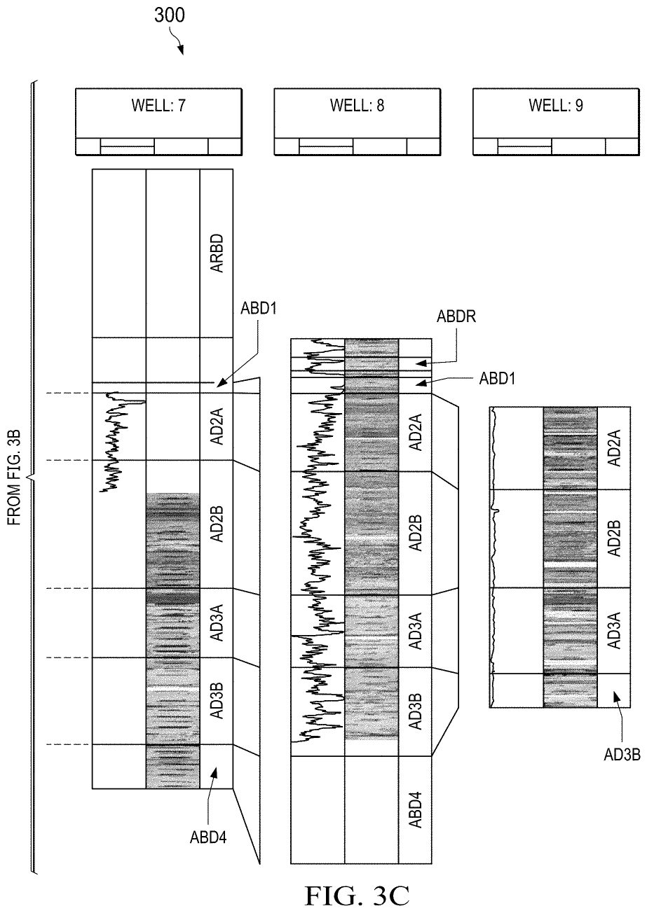

In some implementations, the first step of the workflow is to ingest input data. FIG. 3A, FIG. 3B, and FIG. 3C are each an example illustration of input data from multiple wellbores, in accordance with example implementations of this disclosure. Multiple input data can be organized, quality controlled, cleaned and preprocessed for data ingestion. Example input data can include raw data from lab measurements of core samples from a wellbore, for example, imagery data, such as core photos, and numeric depth-indexed sequence data, such as various core scans and well logs. The input data can come from the same core or multiple cores, and from the same well or multiple wells. The output of the first step is curated data for further processing and modeling. In FIG. 3A, FIG. 3B, and FIG. 3C, the curves are example core gamma ray measurements, and the photos next to the curves are the core photos.

In some implementations, the data acquired from lab measurements are organized into images and numerical depth-indexed sequence data. The images can be a collection of scanned core photos, with various length for the core in each photo (e.g. 9 feet). The images can cover a range of depth from cores in the borehole. The numerical depth-indexed sequence data can be from various lab measurements, such as core gamma ray or sonic log. All data are indexed by depth of the wellbore. Human experts and existing computer programs may be used for quality control and for cleaning the data. For example, blurry images or low-resolution images can be excluded, missing numbers in well logs can be labeled or filled.

In some implementations, additional preprocessing can be carried out, such as checking consistency of vertical and horizontal resolution of images, excluding core images with size of the core in the image being less than a predetermined threshold, and verifying the limit of values in the numerical depth-indexed sequence data (e.g. porosity is a positive number).

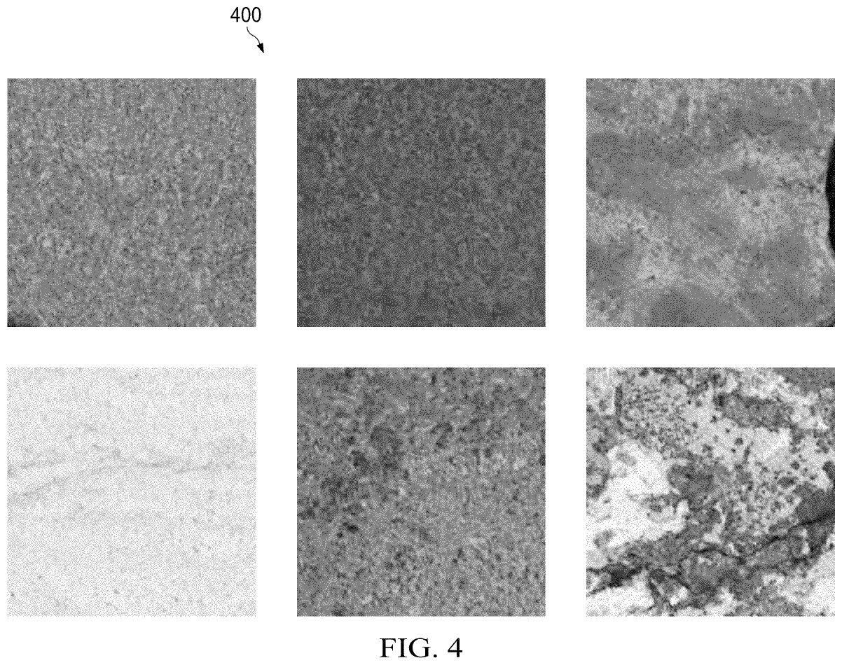

In some implementations, the second step of the workflow is to generate image features and image patches. FIG. 4 illustrates examples of image patches extracted from imagery data of several core samples, in accordance with example implementations of this disclosure. The input imagery data can be core photos. The curated images are preprocessed and analyzed for image characteristics and core textures using computer vision (CV) technologies. Examples of the image characteristics and core textures include red/green/blue (RGB) color model, hue/saturating/value (HSV) color model, and texture recognition based features, such as entropy and Haralick features. The RGB color model can decompose the color of each pixel in the image into 3 components of red/green/blue. The Haralick features can be calculated from a Gray Level Co-occurrence Matrix, (GLCM), a matrix that counts the co-occurrence of neighboring gray levels in the image, and Haralick can describe 14 statistics from the GLCM. The calculation of the image characteristics and core textures can be done at a pixel level or at a predefined window level. The image characteristics and core textures are then aggregated into a depth-indexed profile.

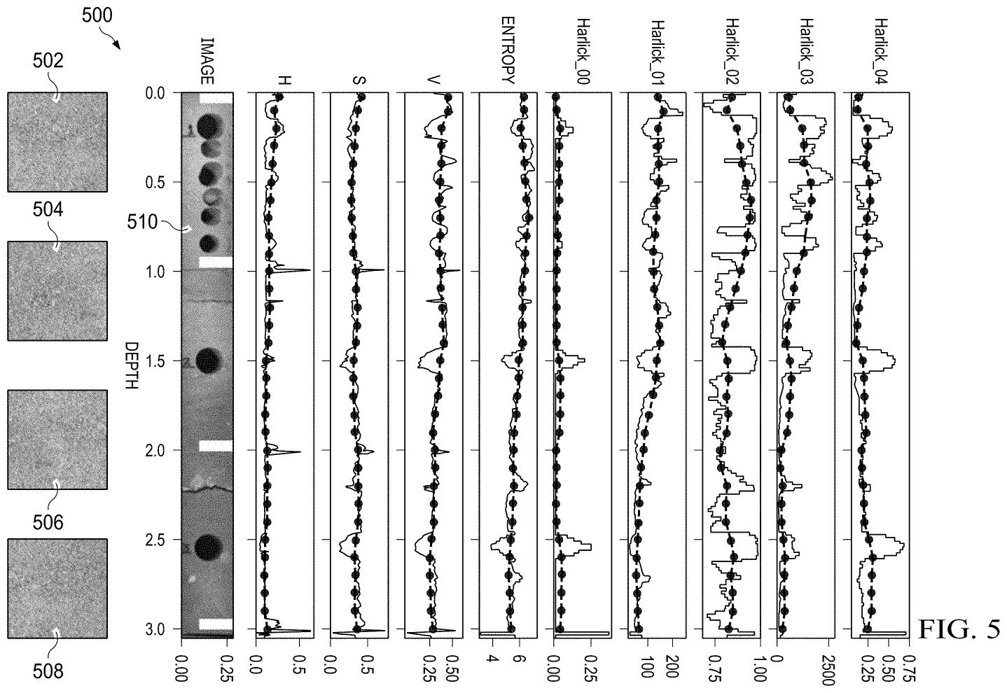

In some implementations, the third step of the workflow is to filter and preprocess the generated image features, which are extracted in the second step as depth-indexed profile, and can also be referred to as numeric sequence data. The numeric sequence data can also include numerical depth-indexed data, such as well logs. The numeric sequence data can be 1-dimensional (1D) sequence data. FIG. 5 illustrates examples of preprocessed image features and corresponding image patches, in accordance with example implementations of this disclosure. The generated image features extracted from image patches can be filtered and preprocessed. For example, part of the image feature data that is out-of-range can be filtered, permeability data can be converted to logarithm scale, and part of the data that is missing or inconsistent can be imputed. The data imputation can be carried out through, for instance, spline interpolation and boxcar smoothing. The spline interpolation can replace missing values by a special type of piecewise polynomial called a spline. The image feature data can be normalized by scaling, for example, using min/max scaler or standard scaler. The data cleansing and preprocessing can be aligned with experts' input and industry standards. The generated image features can be resampled to the same depth interval and aligned by depth with other numeric data such as well logs and core analysis. Misaligned data can be removed.

In some implementations, the numerical depth-indexed sequence data can be further smoothed to eliminate the artifacts from the core images or well logs, such as spikes from marker labels or anomaly from plug holes. For example, the boxcar smoothing uses the average of nearby values to replace the outliers. FIG. 5 shows an example of a 3 feet core image 510, extracted images patches 502 to 508 near core plug #2 in image 510, and some of the image features to the right of image 510. The solid curves are the raw calculated numerical depth-indexed sequence data profile, and the dotted curves are the smoothed profile. The output of the third step can be cleaned, aligned, and processed numerical depth-indexed sequence data.

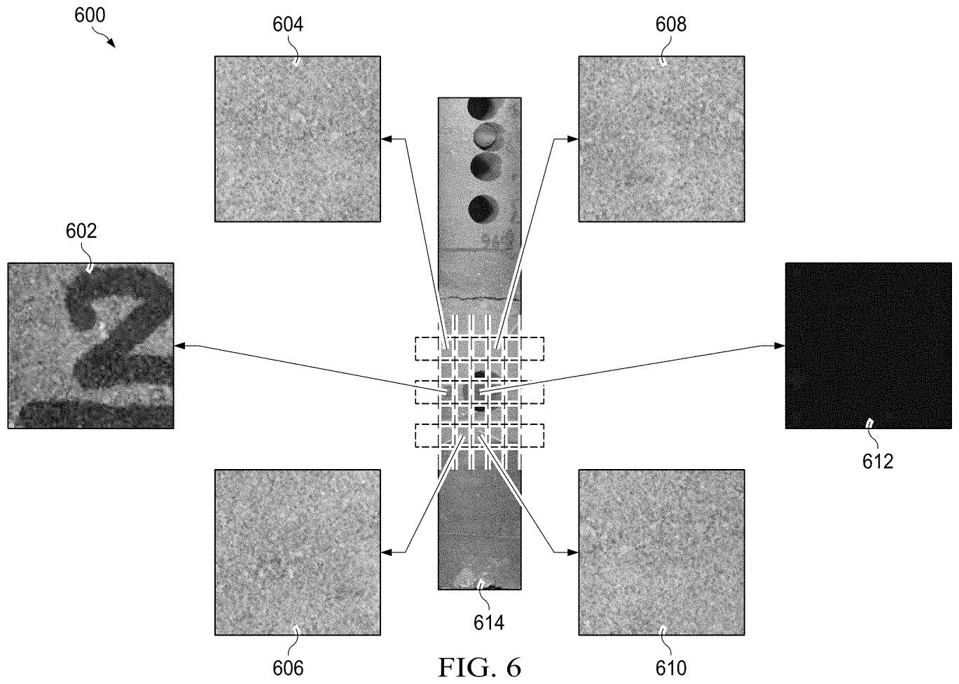

FIG. 6 illustrates examples of image patches extracted near core plugs, in accordance with example implementations of this disclosure. The imagery data can be partitioned into image patches at selective locations. For example, for training dataset, the patches can be extracted from locations near core plugs; and for prediction, the patches can be extracted from locations of interest. The image patches 602 to 612 can be extracted as the rectangles at some of the intersections of the three horizontal bands and the five vertical bands (separated by the five vertical lines) in image 614. The extracted image patches can then be filtered with user-defined metric, such as brightness or entropy, to eliminate artifacts in the image patches. In FIG. 6, image patches 604 to 610 have good brightness and entropy. Image patches 602 and 612 are filtered-out patches, with low brightness due to black marker number or core plug holes.

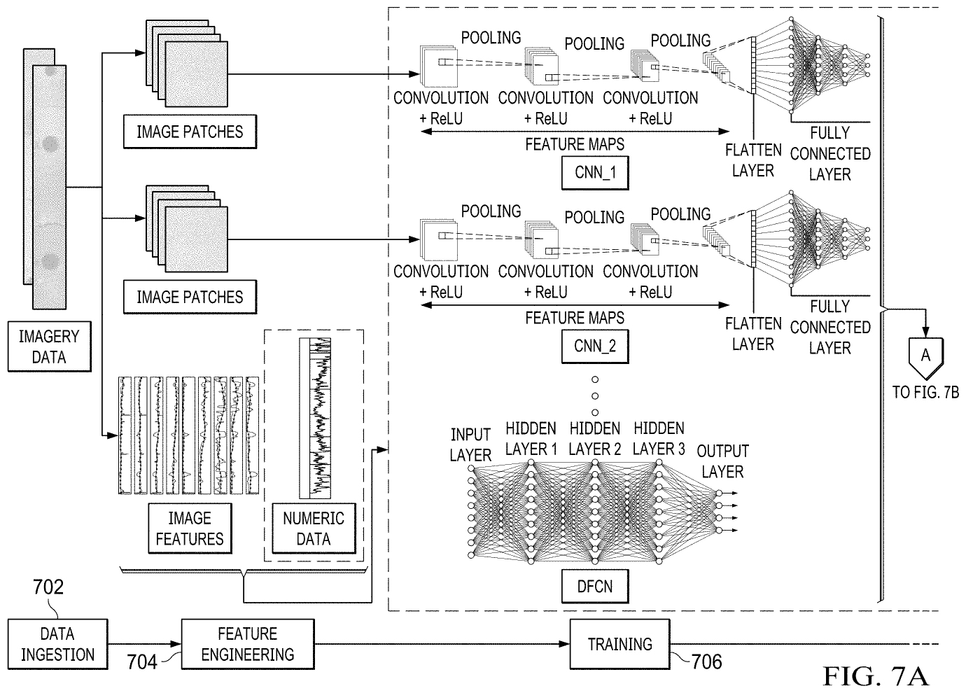

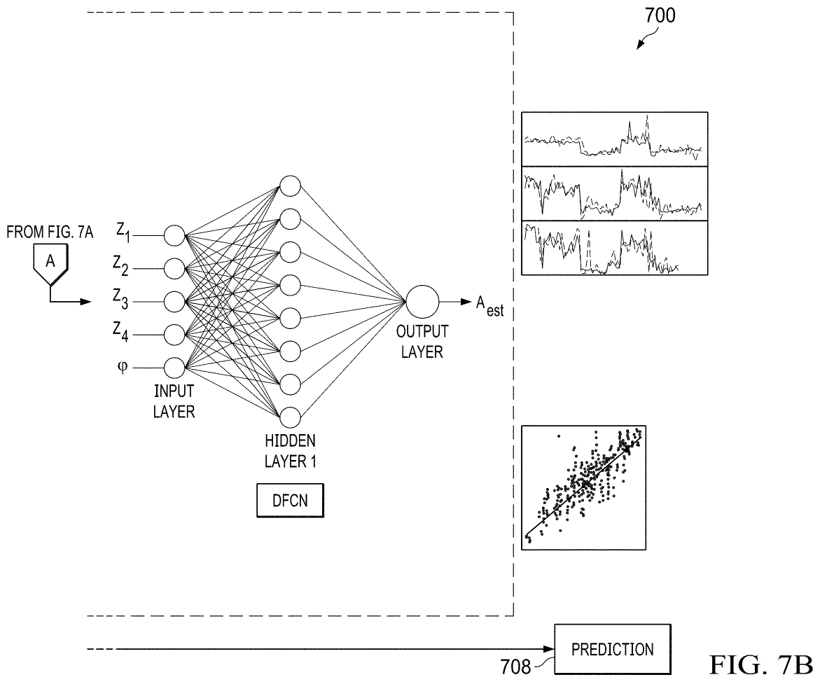

In some implementations, the fourth step of the workflow is to build CNN/DFCN hybrid model with multi-modal multi-dimensional input. FIG. 7A and FIG. 7B illustrate an example of unified machine learning model building workflow, in accordance with example implementations of this disclosure.

In some implementations, the unified machine learning model is trained for target rock properties using ground truth core-plug measurements, and the training of the unified machine learning model includes the following steps. The model takes as input the image patches and the numerical depth-indexed sequence data, evaluates the error in model output with respect to the ground truth using loss function defined by the user (e.g. mean square error (MSE)), applies techniques such as back propagation to update the coefficients in the model according to the evaluated error, and uses an optimizer (e.g. stochastic gradient descent (SGD) or Adam) to iteratively minimize the loss function until the predetermined criteria for the model are satisfied.

In some implementations, the unified machine learning model includes a set of sub-models to accomplish the multi-modal multi-dimensional inputs. First, a set of CNN models can be used to extract patterns out of different imagery data. For example, CNN_1 can be used for white light core images, CNN_2 can be used for core CT scans, and another CNN model can be used for borehole images. Next, a DFCN model can be used to process multiple numeric value inputs, for example, the image features generated form imagery data and numeric data such as well logs. Then another DFCN regressor (the DFCN model in FIG. 7B) can be used to combine the set of CNN models and the DFCN model to predict the target rock properties.

In some implementations, the CNN models take image patches as input, and include multiple hidden layers of convolutional layers, pooling layers, or fully connected layers, in addition to other building blocks (e.g. batch normalization, drop out). The CNN models output vectors of encoded features in a latent space, which can be fed into the DFCN model in FIG. 7B.

In some implementations, the DFCN model below the CNN models in FIG. 7A can be used to process multiple numeric value inputs, for example, the image features and well logs. Additional building blocks may be used, such as batch normalization, drop out, etc. The DFCN model outputs vectors of encoded features in a latent space, which can be fed into the DFCN model in FIG. 7B.

In some implementations, the DFCN model in FIG. 7B takes the output of the set of CNN models and the DFCN model. Additional building blocks can be used, such as batch normalization, drop out, etc. The DFCN model outputs the target rock properties, such as porosity, density, and permeability.

In some implementations, by combining the set of CNN models and the DFCN model in FIG. 7A with the DFCN model in FIG. 7B, the complete model can handle multi-modal multi-dimensional input in a unified architecture for machine learning modeling.

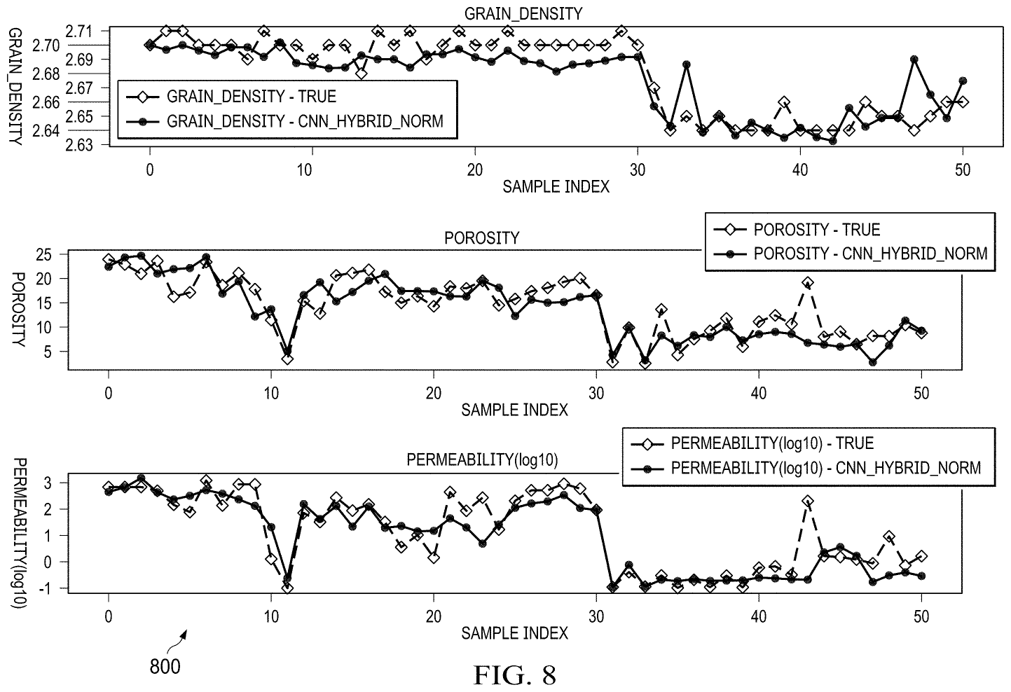

In some implementations, the fifth step of the workflow is to predict rock properties using the trained model. FIG. 8 illustrates example results of rock property prediction, in accordance with example implementations of this disclosure. The trained unified machine learning model can be applied to new data sets to predict the rock properties, such as grain density, porosity, and permeability. The prediction can be applied in different ways, depending on user needs. In one example, the model can be used to predict the desired properties for fresh cores before starting the core description in the hotshot room (few hours after core slabbing). In this case, the core plug based measurements may not be ready in time for training the model. The offset wells can be used to do the model training and the models can then be applied to the fresh cores for prediction. In another example, the user wants to predict the properties for legacy cores for high resolution analysis. For legacy cores, core plug based measurements have been completed by the time when the legacy cores re revisited. The core property measurements from plug analysis can be used to do the training, and the models are then applied to the cores with new depths.

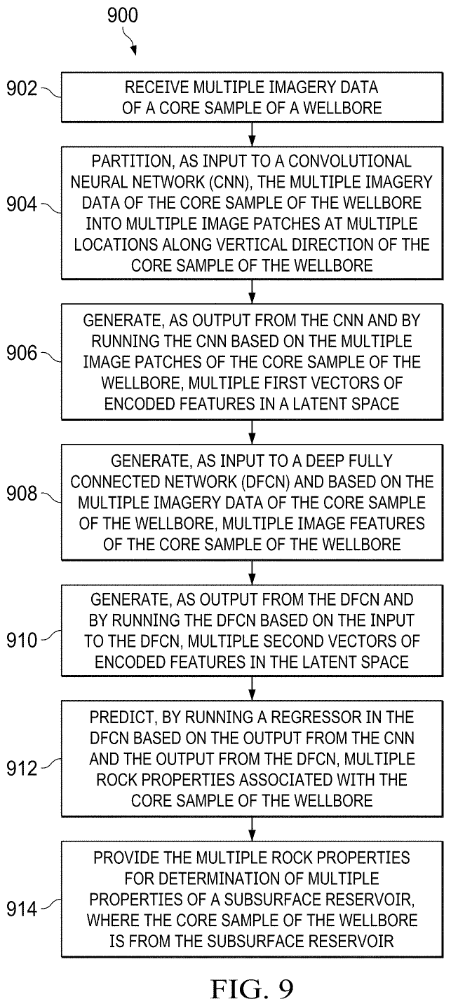

FIG. 9 illustrates an example method for implementing multi-modal and multi-dimensional geological core property prediction using unified machine learning modeling.

At 902, a computer system receives multiple imagery data and numerical depth-indexed sequence data of a core sample of a wellbore.

At 904, the computer system partitions, as input to a convolutional neural network (CNN), the multiple imagery data of the core sample of the wellbore into multiple image patches at multiple locations along vertical direction of the core sample of the wellbore.

At 906, the computer system generates, as output from the CNN and by running the CNN based on the multiple image patches of the core sample of the wellbore, multiple first vectors of encoded features in a latent space.

At 908, the computer system generates, as input to a deep fully connected network (DFCN) and based on the multiple imagery data of the core sample of the wellbore, multiple image features of the core sample of the wellbore, where the multiple image features of the core sample of the wellbore are associated with numerical features of the multiple imagery data of the core sample of the wellbore.

At 910, the computer system generates, as output from the DFCN and by running the DFCN based on the input to the DFCN, multiple second vectors of encoded features in the latent space.

At 912, the computer system predicts, by running a regressor in the DFCN based on the output from the CNN and the output from the DFCN, multiple rock properties associated with the core sample of the wellbore.

At 914, the computer system provides the multiple rock properties for determination of multiple properties of a subsurface reservoir, where the core sample of the wellbore is from the subsurface reservoir.

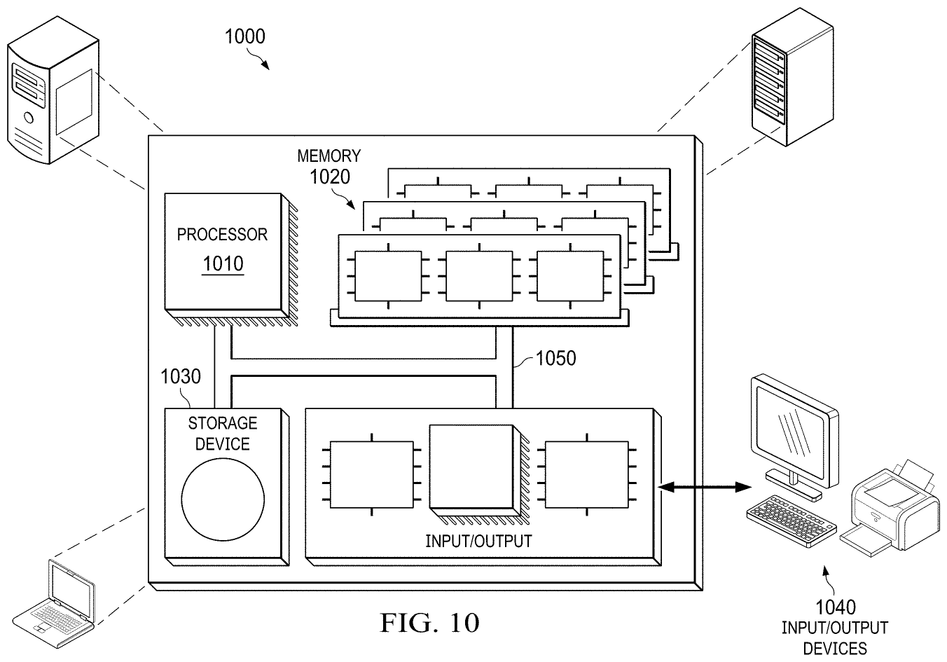

FIG. 10 illustrates a schematic diagram of an example computing system 1000. The system 1000 can be used for the operations described in association with the implementations described herein. For example, the system 1000 may be included in any or all of the server components discussed herein. The system 1000 includes a processor 1010, a memory 1020, a storage device 1030, and an input/output device 1040. The components 1010, 1020, 1030, and 1040 are interconnected using a system bus 1050. The processor 1010 is capable of processing instructions for execution within the system 1000. In some implementations, the processor 1010 is a single-threaded processor. The processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In some implementations, the memory 1020 is a computer-readable medium. The memory 1020 is a volatile memory unit. The memory 1020 is a non-volatile memory unit. The storage device 1030 is capable of providing mass storage for the system 1000. The storage device 1030 is a computer-readable medium. The storage device 1030 may be a floppy disk device, a hard disk device, an optical disk device, or a tape device. The input/output device 1040 provides input/output operations for the system 1000. The input/output device 1040 includes a keyboard and/or pointing device. The input/output device 1040 includes a display unit for displaying graphical user interfaces.

Certain aspects of the subject matter described here can be implemented as a method. One or more imagery data of a core sample of a wellbore are received. The one or more imagery data of the core sample of the wellbore are partitioned, as input to a convolutional neural network (CNN), into one or more image patches at one or more locations along vertical direction of the core sample of the wellbore. One or more first vectors of encoded features in a latent space are generated as output from the CNN and by running the CNN based on the one or more image patches of the core sample of the wellbore. One or more image features of the core sample of the wellbore are generated as input to a deep fully connected network (DFCN) and based on the one or more imagery data of the core sample of the wellbore. The one or more image features of the core sample of the wellbore are associated with numerical features of the one or more imagery data of the core sample of the wellbore. One or more second vectors of encoded features in the latent space are generated as output from the DFCN and by running the DFCN based on the input to the DFCN. One or more rock properties associated with the core sample of the wellbore are predicted by running a regressor in the DFCN based on the output from the CNN and the output from the DFCN. The one or more rock properties associated with the core sample of the wellbore are provided for determination of one or more properties of a subsurface reservoir. The core sample of the wellbore is from the subsurface reservoir.

An aspect taken alone or combinable with any other aspect includes the following features. The core sample of the wellbore has one or more core plugs removed from the core sample of the wellbore. Generating the one or more image patches includes removing artifacts in the one or more image patches through filtering.

An aspect taken alone or combinable with any other aspect includes the following features. The one or more image features of the core sample of the wellbore include at least one of a red/green/blue (RGB) color model, a hue/saturating/value (HSV) color model, or one or more Haralick features.

An aspect taken alone or combinable with any other aspect includes the following features. Generating the one or more image features of the core sample of the wellbore includes at least one of generating the RGB color model by decomposing color of each pixel of the one or more imagery data into three components of red, green, and blue, or calculating the one or more Haralick features from a gray level co-occurrence matrix (GLCM). The GLCM is associated with co-occurrence of neighboring gray levels in the one or more imagery data. The one or more Haralick features are associated with one or more statistics from the GLCM.

An aspect taken alone or combinable with any other aspect includes the following features. Before the one or more second vectors of encoded features in the latent space are generated as the output from the DFCN and by running the DFCN using the input to the DFCN, one or more numerical sequence data indexed by depth of the wellbore is received, and one or more numeric value inputs associated with the core sample of the wellbore are generated as part of the input to the DFCN and based on the one or more numerical sequence data indexed by the depth of the wellbore.

An aspect taken alone or combinable with any other aspect includes the following features. The one or more numerical sequence data indexed by the depth of the wellbore include one or more well logs indexed by the depth of the wellbore.

An aspect taken alone or combinable with any other aspect includes the following features. The one or more numerical sequence data indexed by the depth of the wellbore are resampled to the same depth interval. The one or more resampled numerical sequence data are aligned.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method for geological core property prediction using machine learning modeling, comprising:
receiving a plurality of imagery data of a core sample of a wellbore;
partitioning, as input to a convolutional neural network (CNN), the plurality of imagery data of the core sample of the wellbore into a plurality of image patches at a plurality of locations along vertical direction of the core sample of the wellbore;
generating, as output from the CNN and by running the CNN based on the plurality of image patches of the core sample of the wellbore, a plurality of first vectors of encoded features in a latent space;
generating, as input to a deep fully connected network (DFCN) and based on the plurality of imagery data of the core sample of the wellbore, a plurality of image features of the core sample of the wellbore, wherein the plurality of image features of the core sample of the wellbore are associated with numerical features of the plurality of imagery data of the core sample of the wellbore;
generating, as output from the DFCN and by running the DFCN based on the input to the DFCN, a plurality of second vectors of encoded features in the latent space;
predicting, by running a regressor in the DFCN based on the output from the CNN and the output from the DFCN, a plurality of rock properties associated with the core sample of the wellbore; and
providing the plurality of rock properties for determination of a plurality of properties of a subsurface reservoir, wherein the core sample of the wellbore is from the subsurface reservoir.

2. The computer-implemented method according to claim 1, wherein the core sample of the wellbore has a plurality of core plugs removed from the core sample of the wellbore, and wherein generating the plurality of image patches comprises removing artifacts in the plurality of image patches through filtering.

3. The computer-implemented method according to claim 1, wherein the plurality of image features of the core sample of the wellbore comprise at least one of a red/green/blue (RGB) color model, a hue/saturating/value (HSV) color model, or a plurality of Haralick features.

4. The computer-implemented method according to claim 3, wherein generating the plurality of image features of the core sample of the wellbore comprises at least one of generating the RGB color model by decomposing color of each pixel of the plurality of imagery data into three components of red, green, and blue, or calculating the plurality of Haralick features from a gray level co-occurrence matrix (GLCM), wherein the GLCM is associated with co-occurrence of neighboring gray levels in the plurality of imagery data, and wherein the plurality of Haralick features are associated with a plurality of statistics from the GLCM.

5. The computer-implemented method according to claim 1, wherein the method further comprises:
before generating, as the output from the DFCN and by running the DFCN using the input to the DFCN, the plurality of second vectors of encoded features in the latent space:
receiving a plurality of numerical sequence data indexed by depth of the wellbore; and
generating, as part of the input to the DFCN and based on the plurality of numerical sequence data indexed by the depth of the wellbore, a plurality of numeric value inputs associated with the core sample of the wellbore.

6. The computer-implemented method according to claim 5, wherein the plurality of numerical sequence data indexed by the depth of the wellbore comprise a plurality of well logs indexed by the depth of the wellbore.

7. The computer-implemented method according to claim 6, wherein the method further comprises:
resampling the plurality of numerical sequence data indexed by the depth of the wellbore to the same depth interval; and
aligning the plurality of resampled numerical sequence data.

8. A non-transitory, computer-readable medium storing one or more instructions executable by a computer system to perform operations for geological core property prediction using machine learning modeling, the operations comprising:
receiving a plurality of imagery data of a core sample of a wellbore;
partitioning, as input to a convolutional neural network (CNN), the plurality of imagery data of the core sample of the wellbore into a plurality of image patches at a plurality of locations along vertical direction of the core sample of the wellbore;
generating, as output from the CNN and by running the CNN based on the plurality of image patches of the core sample of the wellbore, a plurality of first vectors of encoded features in a latent space;
generating, as input to a deep fully connected network (DFCN) and based on the plurality of imagery data of the core sample of the wellbore, a plurality of image features of the core sample of the wellbore, wherein the plurality of image features of the core sample of the wellbore are associated with numerical features of the plurality of imagery data of the core sample of the wellbore;
generating, as output from the DFCN and by running the DFCN based on the input to the DFCN, a plurality of second vectors of encoded features in the latent space;
predicting, by running a regressor in the DFCN based on the output from the CNN and the output from the DFCN, a plurality of rock properties associated with the core sample of the wellbore; and
providing the plurality of rock properties for determination of a plurality of properties of a subsurface reservoir, wherein the core sample of the wellbore is from the subsurface reservoir.

9. The non-transitory, computer-readable medium according to claim 8, wherein the core sample of the wellbore has a plurality of core plugs removed from the core sample of the wellbore, and wherein generating the plurality of image patches comprises removing artifacts in the plurality of image patches through filtering.

10. The non-transitory, computer-readable medium according to claim 8, wherein the plurality of image features of the core sample of the wellbore comprise at least one of a red/green/blue (RGB) color model, a hue/saturating/value (HSV) color model, or a plurality of Haralick features.

11. The non-transitory, computer-readable medium according to claim 10, wherein generating the plurality of image features of the core sample of the wellbore comprises at least one of generating the RGB color model by decomposing color of each pixel of the plurality of imagery data into three components of red, green, and blue, or calculating the plurality of Haralick features from a gray level co-occurrence matrix (GLCM), wherein the GLCM is associated with co-occurrence of neighboring gray levels in the plurality of imagery data, and wherein the plurality of Haralick features are associated with a plurality of statistics from the GLCM.

12. The non-transitory, computer-readable medium according to claim 8, wherein the operations further comprise:
before generating, as the output from the DFCN and by running the DFCN using the input to the DFCN, the plurality of second vectors of encoded features in the latent space:
receiving a plurality of numerical sequence data indexed by depth of the wellbore; and
generating, as part of the input to the DFCN and based on the plurality of numerical sequence data indexed by the depth of the wellbore, a plurality of numeric value inputs associated with the core sample of the wellbore.

13. The non-transitory, computer-readable medium according to claim 12, wherein the plurality of numerical sequence data indexed by the depth of the wellbore comprise a plurality of well logs indexed by the depth of the wellbore.

14. The non-transitory, computer-readable medium according to claim 13, wherein the operations further comprise:
resampling the plurality of numerical sequence data indexed by the depth of the wellbore to the same depth interval; and
aligning the plurality of resampled numerical sequence data.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for geological core property prediction using machine learning modeling, the one or more operations comprising:
receiving a plurality of imagery data of a core sample of a wellbore;
partitioning, as input to a convolutional neural network (CNN), the plurality of imagery data of the core sample of the wellbore into a plurality of image patches at a plurality of locations along vertical direction of the core sample of the wellbore;
generating, as output from the CNN and by running the CNN based on the plurality of image patches of the core sample of the wellbore, a plurality of first vectors of encoded features in a latent space;
generating, as input to a deep fully connected network (DFCN) and based on the plurality of imagery data of the core sample of the wellbore, a plurality of image features of the core sample of the wellbore, wherein the plurality of image features of the core sample of the wellbore are associated with numerical features of the plurality of imagery data of the core sample of the wellbore;
generating, as output from the DFCN and by running the DFCN based on the input to the DFCN, a plurality of second vectors of encoded features in the latent space;
predicting, by running a regressor in the DFCN based on the output from the CNN and the output from the DFCN, a plurality of rock properties associated with the core sample of the wellbore; and
providing the plurality of rock properties for determination of a plurality of properties of a subsurface reservoir, wherein the core sample of the wellbore is from the subsurface reservoir.

16. The computer-implemented system according to claim 15, wherein the core sample of the wellbore has a plurality of core plugs removed from the core sample of the wellbore, and wherein generating the plurality of image patches comprises removing artifacts in the plurality of image patches through filtering.

17. The computer-implemented system according to claim 15, wherein the plurality of image features of the core sample of the wellbore comprise at least one of a red/green/blue (RGB) color model, a hue/saturating/value (HSV) color model, or a plurality of Haralick features.

18. The computer-implemented system according to claim 17, wherein generating the plurality of image features of the core sample of the wellbore comprises at least one of generating the RGB color model by decomposing color of each pixel of the plurality of imagery data into three components of red, green, and blue, or calculating the plurality of Haralick features from a gray level co-occurrence matrix (GLCM), wherein the GLCM is associated with co-occurrence of neighboring gray levels in the plurality of imagery data, and wherein the plurality of Haralick features are associated with a plurality of statistics from the GLCM.

19. The computer-implemented system according to claim 15, wherein the one or more operations further comprise:
before generating, as the output from the DFCN and by running the DFCN using the input to the DFCN, the plurality of second vectors of encoded features in the latent space:
receiving a plurality of numerical sequence data indexed by depth of the wellbore; and
generating, as part of the input to the DFCN and based on the plurality of numerical sequence data indexed by the depth of the wellbore, a plurality of numeric value inputs associated with the core sample of the wellbore.

20. The computer-implemented system according to claim 19, wherein the plurality of numerical sequence data indexed by the depth of the wellbore comprise a plurality of well logs indexed by the depth of the wellbore.
